(19) United States
(12) Patent Application Publication
(10) Pub. No.: US 2018/0198265 A1
(43) Pub. Date: Jul. 12, 2018

(54) Sleeving Pipe for a Sensor and a Shell Assembly with the Same

(71) Applicant: IR-Tec International Ltd., Taoyuan City (TW)

(72) Inventor: Wen-I Huang, Taoyuan City (TW)

(21) Appl. No.: 15/860,709

(22) Filed: Jan. 3, 2018

(30) Foreign Application Priority Data
Jan. 11, 2017 (TW) 106200477

(51) Int. Cl. H02G 3/04; G01D 11/30

(52) U.S. Cl. CPC H02G 3/0462; G01D 11/30

(57) ABSTRACT

A shell assembly for a sensor has a shell and at least one sleeving pipe. The shell forms a perforation and a thread portion. The perforation is on a surface of the shell. Thread portion is on another surface of the shell. The sleeving pipe and the thread portion are threaded with each other and the sleeve pipe has an internal thread section and an external thread section. As the sleeving pipe is threaded with the shell of the sensor, the shell assembly not only can fix the shell of the sensor, but also can allow the wires of the sensor to pass through the sleeving pipes, and the wires are arranged orderly along a preferred route connecting to devices or the power source, which causes maintenance work to become easier.

### BACKGROUND OF THE INVENTION

### 1. Field of the Invention

The present invention relates to a sleeving pipe and a shell assembly for a sensor, especially to a sleeving pipe to sleeving wires of a sensor and a shell assembly to accommodate a sensor and wires of said sensor.

### 2. Description of the Prior Arts

For enhanced convenience in daily life, many devices are connected to a sensor for detecting changes in the environment and thus the devices can be adjusted according to the changes. Thus, combinations of the devices and the sensor become smart systems or Internet of Things devices. For instance, if a lamp, e.g., a ceiling lamp or a wall lamp, is connected with a sensor which is capable of detecting a position of a human being or a brightness of an environment, the lamp can be turned on, turned off, or adjust luminance in accordance with detection results of the sensor. Most conventional devices do not have any sensor, but, for the purpose of saving energy, a conventional device can be connected with a sensor to control the conventional device and save energy. One common way to arrange a sensor is that a shell of the sensor goes through a case or a frame of the device, and then a nut is mounted on a part of the sensor that is in the case or the frame of the device, so that the sensor may be fixed.

However, wires of the sensor extend out of the shell of the case, which causes the wires to scatter so that it is hard to arrange the wires in order. Furthermore, if the sensor is connected to multiple devices, the arrangement of the wires may become complicated. Referring to the instance of lamps again, though wires of the lamps can be hidden in a T-bar ceiling, sorting out the wires is still a difficult work for maintenance.

To overcome the shortcomings, the present invention provides a sleeving pipe and a shell assembly to mitigate or obviate the aforementioned problems.

### SUMMARY OF THE INVENTION

The main objective of the present invention is to provide a sleeving pipe and a shell assembly for a sensor.

The sleeving pipe has a first end, a second end, a pipe portion, and a through hole. The first end has an internal thread section. The second end is opposite the first end and has an external thread section. Two ends of the pipe portion are connected to the first end and the second end respectively. The through hole is formed through the pipe portion and extends from the first end to the second end. An inner diameter of the first end is equal to an outer diameter of the second end, and the internal thread section and the external thread section are corresponding to each other in size and shape.

The shell assembly has a shell and at least one aforesaid sleeving pipe. The shell comprises at least one perforation and a thread portion. The at least one perforation is formed through a surface of the shell for a sensor in the shell detecting changes of environment. The thread portion is formed on another surface of the shell and forms an aperture formed through the thread portion. The at least one sleeving pipe fixed on the thread portion.

Consequently, by threading the sleeving pipes and the shell of the sensor, the shell assembly of the present invention not only can fix the shell of the sensor, but also can allow the wires of the sensor to pass through the sleeving pipes. Therefore, with the wires passing through the sleeving pipes, the wires are restricted, and thereby the wires are arranged orderly and the wires connecting the devices or power source can be arranged along a preferred route, which causes maintenance work to become easier.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a shell assembly in accordance with the present invention;

FIG. 2 is an exploded view of the shell assembly in FIG. 1;

FIG. 3 is a cross-sectional view of an L-shaped sleeving pipe of the shell assembly in FIG. 1;

FIG. 4 is a cross-sectional view of a linear-shaped sleeving pipe of the shell assembly in FIG. 1;

FIG. 5 is an end view of the linear-shaped sleeving pipe of the shell assembly in FIG. 4; and

FIG. 6 is an operational schematic view of the shell assembly in FIG. 1.

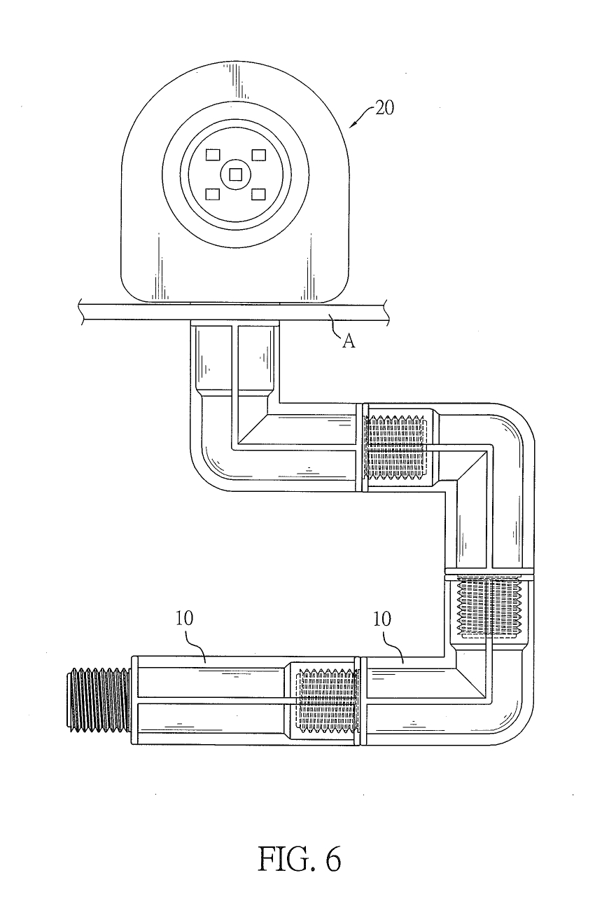

### DETAILED DESCRIPTION OF THE PREFERRED EMBODIMENTS

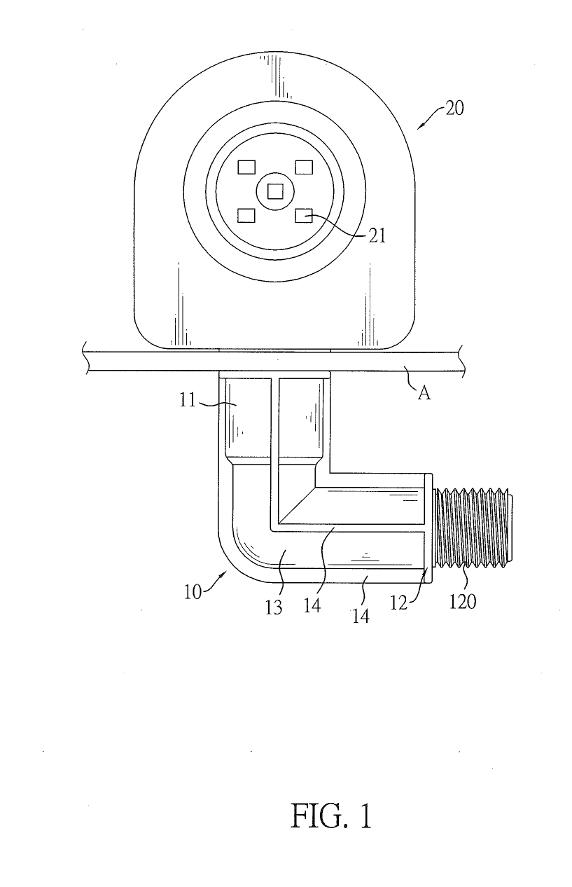

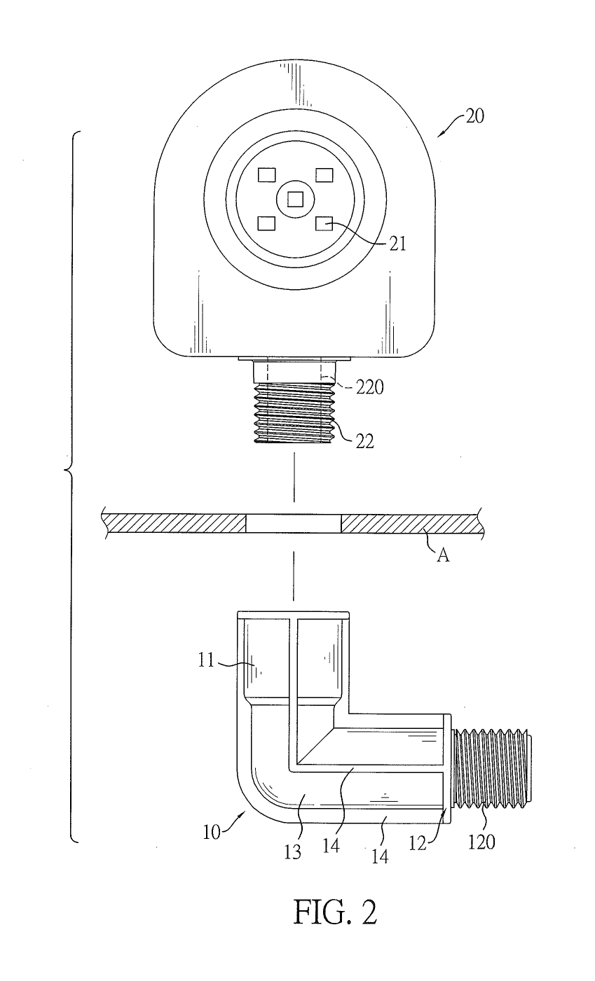

With reference to FIGS. 1 and 2, a shell assembly in accordance with the present invention comprises at least one sleeving pipe 10 and a shell 20

The at least one sleeving pipe 10 can sleeve wires of a sensor, such as a power cable and signal cables. The at least one sleeving pipe 10 comprises a first end 11, a second end 12, a pipe portion 13 and a plurality of strengthening ribs 14.

An inner diameter of the first end 11 equals to an outer diameter of the second end 12. The first end 11 comprises an internal thread section 110. The second end 12 is opposite the first end 11 and comprises an external thread section 120. Thus, the first end 11 of one sleeving pipe 10 can be threaded on the second end 12 of another sleeving pipe 10, so that two sleeving pipes 10 are connected in series. Two ends of the pipe portion 13 are connected to the first end 11 and the second end 12 respectively. In other words, the pipe portion 13 is between the first end 11 and the second end 12. The strengthening ribs 14 form on an outer surface of the pipe portion 13, and extend from the first end 11 to the second end 12, and thereby the sleeving pipe 10 is not easy to be bent and damaged.

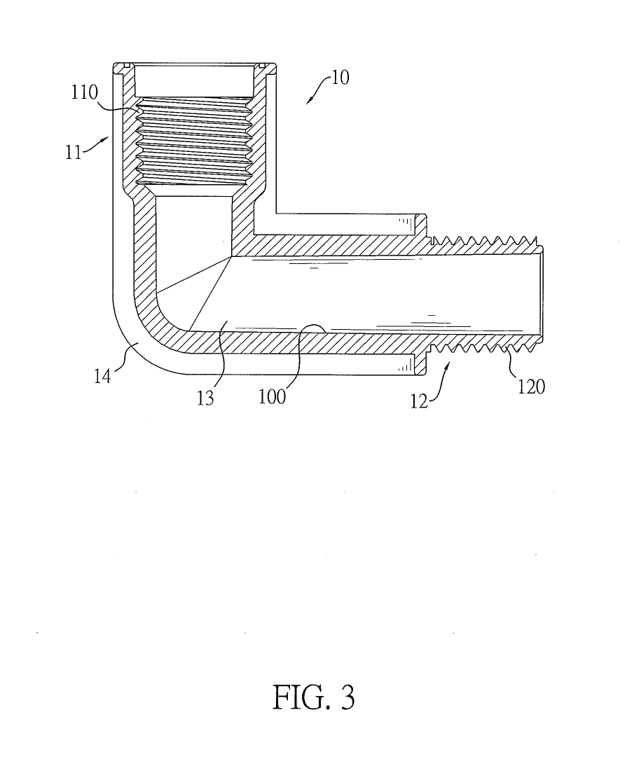

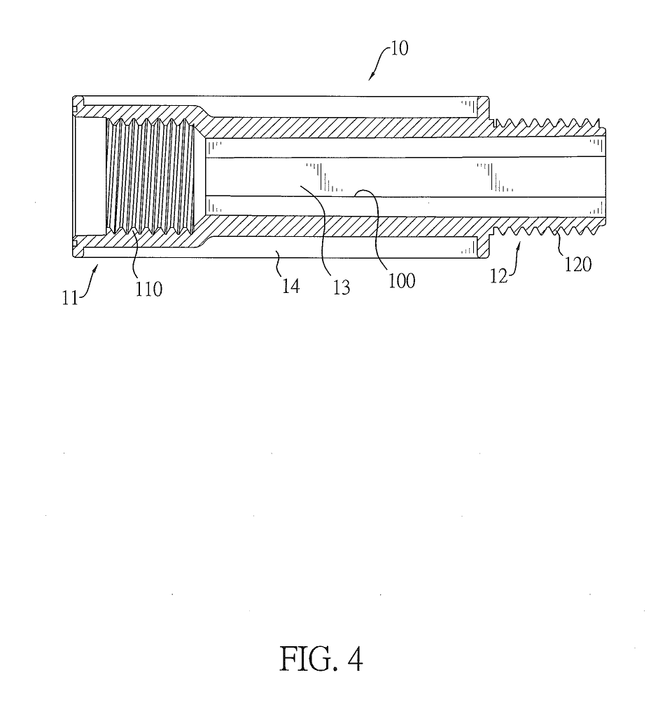

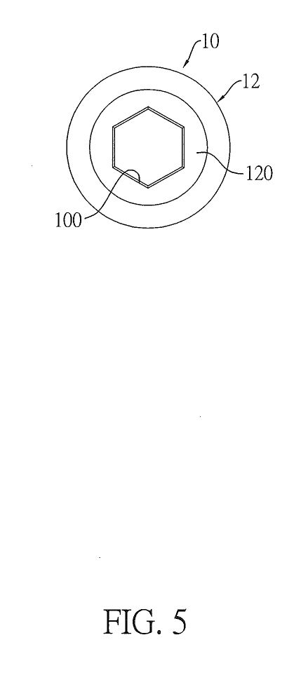

The please also refer to FIG. 3. The sleeving pipe 10 is a hollow pipe, i.e., there is a through hole 100 formed inside the sleeving pipe 10 and extending from the first end 11 to the second end 12. The pipe portion 13 may be an L-shaped pipe. In other words, the L-shaped sleeving pipe 10 forms an angle, and the angle may be, but not limited to, 45 degrees, 60 degrees, 90 degrees, 120 degrees, or 135 degrees. Thus, routes of the wires of the sensor are restricted in the sleeving pipe 10 and extending directions of wires can be changed by the angle of the sleeving pipe 10. Then please also refer to FIGS. 4 and 5. In another embodiment, the pipe portion 13 can be a linear-shaped pipe. The linear-shaped sleeving pipe 10 also comprises a through hole 100, so that the extending direction of wires can keep straight. In the embodiment that the pipe portion 13 is linear-shaped, a cross section of the through hole 100 at the second end 12 is polygonal, e.g. hexagonal, and thereby the linear-shaped sleeving pipe 10 can be fixed or removed by an Allen wrench.

Please refer to FIGS. 1 and 2 again. The shell 20 can be used for accommodating a sensor. The shell 20 comprises at least one perforation 21 and a thread portion 22.

The at least one perforation 21 is formed on a surface of the shell 20, e.g. a bottom surface, and thereby an inner space of the shell 20 can communicate with the exterior environment. In other words, when a sensor is disposed in the shell 20, the sensor can detect changes of the exterior environment.

The thread portion 22 is formed on another surface of the shell 20, such as a top surface or a lateral surface. The shell 20 can be fixed with the aforesaid at least one sleeving pipe 10. The thread portion 22 forms a sleeve and comprises an aperture 220. The aperture 220 communicates with the inner space of the shell 20 and an inner space of the sleeving pipe 10 fixed on the shell 20. In this embodiment, the thread portion 22 protrudes out of the shell 20 and forms outer threads, making the shell 20 capable of being threaded with the internal thread section 110 of the first end 11 of the sleeving pipe 10. In this embodiment, the at least one sleeving pipe 10 is multiple in amount. Therefore, one of the sleeving pipes 10 is fixed on the shell 20, and the remaining sleeving pipes 10 are fixed in series with the second end 12 of the sleeving pipe 10 that is fixed on the shell 20. Besides, the pipe portions of the sleeving pipes 10 are not all L-shaped or linear-shaped. Instead, part of the pipe portions 13 may be L-shaped, and the remaining pipe portions may be linear-shaped.

When installing a sensor, the steps are disassembling the shell 20, putting the sensor into the shell 20, and assembling the shell 20. Thus, the wires of the sensor pass through the aperture 220 of the thread portion 22. Then, the sensor is mounted on a side surface of a plate A with the shell 20, and the thread portion 22 of the shell 20 penetrates the plate A and thus extends to another side of the plate A, which allows a sleeving pipe 10 of the present invention to be threaded with the thread portion 22 of the shell 20 after sleeving the wires. Thus, the plate A is clamped by the shell 20 and the sleeving pipe 10. After that, other sleeving pipes 10 are sleeved on the wires in accordance with a planned wiring route and the sleeving pipes 10 are threaded with each other in series. In particular, the plate A may be a part of a shell of the device or may be part of the T-bar ceiling.

In another embodiment, the thread portion 22 may be formed with inner threads so that the external thread section 120 of the second end 12 of the sleeving pipe 10 can be threaded on the thread portion 22, and thereby a purpose of threading the sleeving pipe 10 and the shell 20 of the sensor is achieved.

Consequently, with threading the sleeving pipes 10 and the shell 20 of the sensor, the shell assembly of the present invention not only can fix the shell 20 of the sensor, but also can allow the wires of the sensor to pass through the sleeving pipes 10. Therefore, with the wires passing through the sleeving pipes 10, the wires are restricted, and thereby the wires are arranged orderly and the routes of wires connecting the devices or power source can be arranged along a preferred route, which causes maintenance work to become easier.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A sleeving pipe for a sensor, the sleeving pipe comprising:
a first end having an internal thread section;
a second end opposite the first end and having an external thread section;
a pipe portion, two ends of the pipe portion connected to the first end and the second end respectively; and
a through hole formed through the pipe portion and extending from the first end to the second end;
wherein an inner diameter of the first end is equal to an outer diameter of the second end, and the internal thread section and the external thread section are corresponding to each other in size and shape.

2. The sleeving pipe as claimed in claim 1 further comprising:
a plurality of strengthening ribs formed on an outer surface of the pipe portion and extending from the first end to the second end.

3. The sleeving pipe as claimed in claim 1, wherein the pipe portion is L-shaped.

4. The sleeving pipe as claimed in claim 2, wherein the pipe portion is L-shaped.

5. The sleeving pipe as claimed in claim 1, wherein the pipe portion is linear-shaped.

6. The sleeving pipe as claimed in claim 2, wherein the pipe portion is linear-shaped.

7. The sleeving pipe as claimed in claim 5, wherein a cross-section of the through hole at the second end is polygonal.

8. The sleeving pipe as claimed in claim 6, wherein a cross-section of the through hole at the second end is polygonal.

9. A shell assembly with at least one sleeving pipe as claimed in claim 1, the shell assembly comprising:
a shell comprising:
at least one perforation formed through a surface of the shell for a sensor in the shell detecting changes of environment; and
a thread portion formed on another surface of the shell and forming:
an aperture formed through the thread portion; and
the at least one sleeving pipe fixed on the thread portion.

10. The sleeving pipe as claimed in claim 9, wherein the thread portion protrudes out of said another surface of the shell and is threaded with the internal thread section of the at least one sleeving pipe.

11. The sleeving pipe as claimed in claim 10, wherein the at least one sleeving pipe is multiple in amount, one end of one of the multiple sleeving pipes is threaded with the thread portion of the shell, and another end of said sleeving pipe is threaded with the remaining sleeving pipes in series.

12. The sleeving pipe as claimed in claim 11, wherein part of the pipe portions of the sleeving pipes are L-shaped, and the pipe portions of the remaining sleeving pipes are linear-shaped.
